(19) United States
(12) Patent Application Publication
(10) Pub. No.: US 2011/0159271 A1
(43) Pub. Date: Jun. 30, 2011

(54) Foam gasket for the protection of photovoltaic modules and method of preparing the same

(75) Inventor: Stephen Yau Sang Cheng, Sheung Shui (HK)

(73) Assignee: Du Pont Apollo Ltd.

(21) Appl. No.: 12/929,081

(22) Filed: Dec. 29, 2010

Related U.S. Application Data
(60) Provisional application No. 61/291,267, filed on Dec. 30, 2009.

(51) Int. Cl. B32B 3/26; C08J 9/35; B29C 43/02; B29C 43/20

(52) U.S. Cl. 428/304.4; 521/50; 264/319; 264/129

(57) ABSTRACT

A foamed gasket used in the photovoltaic module is disclosed. A method of preparing a foamed gasket is also disclosed. According to the present invention, the gasket can effectively protect a photovoltaic module against shock and reduce the possibility of moisture penetrating a seal between rigid surfaces.

### FIELD OF THE INVENTION

The present invention is directed to a foamed gasket used in photovoltaic modules and a method of preparing it. More particularly, the present invention relates to a method of preparing a foamed gasket which can be used in photovoltaic modules to provide a buffer against mechanical stress or shock and a seal against fluids between two rigid surfaces.

### BACKGROUND OF THE INVENTION

A solar cell stores and provides electric energy converted from light energy. A photovoltaic module is a packaged and interconnected assembly of solar cells. The resulting photovoltaic module is used in a larger photovoltaic system to offer electricity for common commercial and residential applications. The solar cells within such systems can be brittle and require protection from mechanical damage during preparation, transportation, installation, and use. They must also be protected from moisture, which corrodes metal contacts and interconnects, thus impairing performance and reducing lifetime.

WO 95/03631 describes a system to absorb shocks by using physical space or voids. WO 95/03631 also discloses gaskets made of traditional ethylene propylene diene Monomer (EPDM) materials.

Generally, the function of a gasket is to provide a buffer against mechanical stress, shield against shock, and seal against fluids between two rigid surfaces. Traditional gaskets are used in windows, doors, and automobiles. Materials used are EPDM, silicones, and nitrile rubbers. Foamed EPDM in particular has been commonly used in automotive seals for a number of years.

Modern foam gasket materials are based on EPDM, rubber and silicones with foam densities typically 0.6 to 0.7 g/cm³ or greater. Low density foams below 0.3 g/cm³ such as polyurethane foams are less durable due to hydrolysis. Specifically in frame-mounted photovoltaic modules, thermosetting EPDM or thermoplastic vulcanizates (TPV) are used to form the gasket between the photovoltaic module and metal frame.

In FIG. 1, a gasket 1 made from EPDM or TPV is provided. It is obvious that the gasket design is not uniformly flat. In addition to the butyl sealant 4, the gasket employs features such as protrusions 6 or ridges 7 to improve sealing and contact to either or both rigid surfaces of the glass 3 and the metal frame 5. Furthermore, the gasket requires an arrow feature 2 to prevent seepage of fluids. These features require fabrication processes such as profile extrusion, which demand greater capital costs.

Consequently, there is still a need for a gasket to protect a photovoltaic module against shock and moisture. The present invention employs low-density foamed materials to reduce cost by allowing for simpler designs and lower manufacturing cost. The low density foams provided in the present invention have not been used for photovoltaic module gaskets in the industry.

### SUMMARY OF THE INVENTION

One embodiment of the present invention is directed to a foamed gasket that comprises a foam having a density in the range of 0.005 to 0.6 g/cm³ used in a photovoltaic module.

In another embodiment of the present invention, a method of preparing a foamed gasket is provided. The method comprises providing a foam having a density in the range of 0.005 to 0.6 g/cm³, followed by molding the foam into foam sheets and forming the gasket from the resulting foam sheets.

In another embodiment of the present invention, the polymer or polymers used in the present invention do not contain any functional groups which can be hydrolyzed.

In another embodiment of the present invention, a compressible foam is used in the present invention. The compressible foam has a density of 0.05 to 0.25 g/cm³.

In another embodiment of the present invention, the compressible foam used in the present invention can be compressed by external applied force or mechanical load by greater than or equal to 5%, preferably 50%, more preferably 98%, in the axis of applied force or mechanical load without inherent material failure.

In another embodiment, the compressible foam has an open-celled structure or a close-celled structure, preferably a close-celled structure. In the case of an open-celled structure, the foam surface is covered with a skin layer which prevents fluids from entering the open-celled structures.

In another embodiment of the present invention, a rigid non-compressible foam is used in the present invention. The rigid non-compressible foam has a density of 0.02 to 0.2 g/cm3.

In another embodiment of the present invention, the rigid non-compressible foam has an open-celled structure or a close-celled structure, preferably a close-celled structure. In the case of an open-celled structure, the foam surface is covered with a skin layer which prevents fluids from entering the open-celled structures.

The gasket of the present invention is intended for use in photovoltaic modules, but can be used in other applications with a frame construction requiring a similar gasket function, such as, but not limited to, LCD devices.

The above summary of the present invention is not intended to describe each illustrated embodiment or every implementation of the present invention. The following figures and detailed description more particularly exemplify these embodiments.

### BRIEF DESCRIPTION OF THE DRAWINGS

The present invention may be more completely understood in consideration of the following detailed description of the preferred embodiments in connection with the accompanying diagrams.

FIG. 1 shows a schematic cross sectional view of a gasket used in the prior art.

FIG. 2 shows the use of a compressible foamed gasket of the present invention to protect glass from shock and stress in a metal frame.

FIG. 3 shows the use of a rigid non-compressible foamed gasket of the present invention to protect glass from shock and stress in a metal frame.

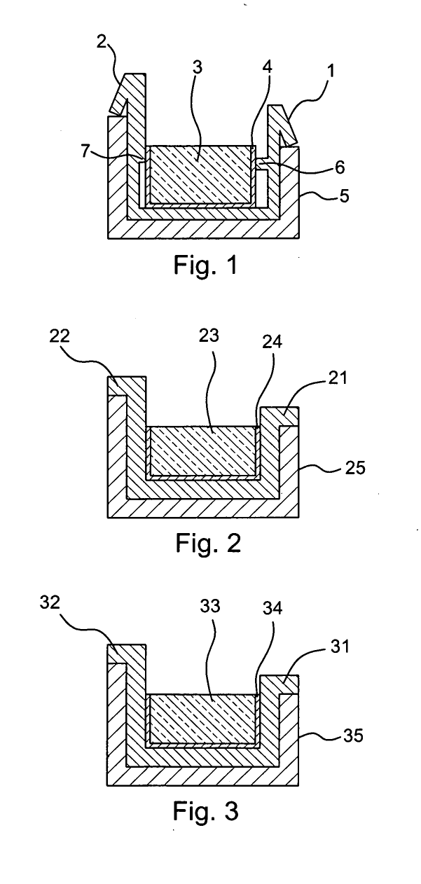

### DETAILED DESCRIPTION OF THE INVENTION

The present invention is to provide a foamed gasket that comprises a foam having a density in the range of 0.005 to 0.6 g/cm³ used in a photovoltaic module. The present invention is also to provide a method of preparing a foamed gasket. In particular, a method of preparing a foamed gasket which can be used in photovoltaic modules is disclosed in the present invention, wherein the methods and principles used in photovoltaic cells are well known to persons having ordinary skill in the art, and thus will not be further described hereafter.

The foamed gasket of the present invention comprising a foam with a density in the range of 0.005 to 0.6 g/cm³ is used in photovoltaic modules.

In addition, the method of the present invention comprises providing a foam having a density in the range of 0.005 to 0.6 g/cm³, molding the foam into foam sheets, and forming the gasket from the resulting foam sheets. The gasket is used as a protective buffer in photovoltaic modules.

The foam used in the present invention refers to a foam made from polymeric compositions which are known to persons having ordinary skill in the art, as long as the foam has a density in the range of 0.005 to 0.6 g/cm³. For the sake of weatherability and durability, the polymer or polymers used in the present invention are not prone to contain any functional groups which can be hydrolyzed. Take polyethylene and polyurethane as examples. Polyethylene is a suitable material for forming the foam in the prevent invention because it does not contain any functional groups on the polymer which can be attached to by water. In contrast, polyurethane is not suitable for the present invention because it contains functional groups which react with water resulting in the polymer being broken down.

In one embodiment of the present invention, a compressible foam having a density measured at 23° C. in the range between 0.005 to 0.6 g/cm³, preferably between 0.05 to 0.25 g/cm³, is used. If the module is next to the metal frame, the gasket made from compressible foam is designed to be initially thicker than the space between the frame and the module so that the foamed gasket undergoes compression to ensure intimate contact with both rigid surfaces. In contrast to conventional solid thermosetting or thermoplastic gaskets, no features such as protrusions or ridges on the surface of the foamed gasket are required in this embodiment. In other words, gasket made from compressible foam acts as a superior buffer against mechanical stress and shock by allowing greater freedom of movement compared to conventional solid gaskets.

Numerous compressible foam materials or compressible foams already available in the market can be employed in the present invention. An example of a compressible foam suitable for such use can be seen in the formulation shown in Table 1, which is publicly available information disclosed in a promotional brochure from The Dow Chemical Company titled “Features and Benefits of ENGAGE in Footwear Foams.”

TABLE 1

| | Relative weights (parts per |
|---|---|
| Material | hundred polymer; PHR) |
| Engage 8003 | 25 |
| Ethylenevinylacetate (18% | 75 |
| vinyl acetate copolymer) | |
| Calcium Carbonate | 5 |
| Dicumylperoxide | 0.4 |
| Azodicarbamide | 4.3 |
| Zinc Oxide | 0.5 |
| Zinc Stearate | 0.5 |
| Titanium Dioxide | 1.5 |

The brochure describes the above materials being compounded at 100 to 110° C., after which the compound was cured and foamed at 155 to 165° C., followed by a final compression molding step under a 40% compression at 150° C. to yield the final close-celled foam sample. Some relevant foam properties are listed in Table 2:

TABLE 2

| Selected foam property | Property value |
|---|---|
| Density | 0.21 g/cm³ |
| Compression set at 45° C. for 6 | 40% |
| hours | |

The polymers in the exemplary foam are Engage 8003, a copolymer of ethylene and 1-octene, and ethylenevinylacetate, neither of which hydrolyze in the environment and both of which have excellent weatherability.

The gasket made from the compressible foam can be compressed by external applied force or mechanical load by at least 5% in the axis of applied force without inherent material failure such as cracking or rupture. Preferably, the gasket can be compressed by external applied force or mechanical load by at least 50%. More preferably, the gasket can be compressed by external applied force or mechanical load by at least 98%.

As is well known to persons having ordinary skill in the art, foam generally has one of two types of structures: open-celled or close-celled. In the present invention, close-celled foam is preferred, but either type can be employed.

When open-celled foam is used, the foam surface is covered with a skin layer, preventing fluids from entering the open-celled structures. The materials of the skin layer used in the present invention is not particularly limited insofar as it can be used to prevent fluids from entering the open-celled structure of the foam. One way of forming a skin layer is to apply a waterproof coating, such as paints similar to those used for outdoor waterproofing uses, on top of the foam.

In another embodiment of the present invention, a rigid non-compressible foam having a density measured 23° C. in the range between 0.005 to 0.6 g/cm³, preferably between 0.02 to 0.2 g/cm³, is employed. Exemplary rigid non-compressible foams include expanded polystyrene and polypropylene foams. The gasket made from the rigid non-compressible foam acts as a buffer against shock in the same way that common consumer products are protected by similar foams from breaking.

An example of a rigid non-compressible foam is an expanded polystyrene foam. Polystyrene foams are used in numerous applications, including protective packaging used in the shipment of electronic devices and building insulation. The example may have properties common to many polystyrene foams, such as that of Highload 40, the properties of which can be seen from The Dow Chemical Company product brochure titled “Styrofoam™ Highload 40, 60 and 100 Extruded Polystyrene Irisulation,” where the compressive strength is equal to or greater than 40 pounds per square inch. The density of the Highload 40 is not stated in the brochure, but it can be found on the company's customer website to be 1.8 pounds per cubic foot, equivalent to 0.029 g/cm³. The compressive strength greatly exceeds that required to function in a photovoltaic module. In addition, polystyrene does not contain any functional groups which can be hydrolyzed, and other polymers with the same function can also be used.

For a rigid non-compressible foam, the compressive strength needs to exceed the worst case load acting on the foam, which is for a module to be upright on its shortest edge, resulting in the edge area bearing the entire weight of the module. Taking as an example a glass to glass photovoltaic module of dimensions 1.4×1.1 m² made from 2 pieces of glass with respective thickness of 3 and 4 mm and weighing approximately 60 pounds, the force acting on the edge would distribute over 12 square inches of area on the perimeter, resulting in a compressional stress of 5 pounds per square inch.

Suitable foam sheets can be made with various well-known manufacturing techniques. Exemplary techniques include traditional batch compression foaming and extrusion foaming processes. Secondary processes such as electron beam crosslinking may be applied. Since the sheets can be easily cut into strips of desired widths, the resulting foamed gasket can be used for multiple photovoltaic modules of different dimensions as well as with multiple frame designs.

For a better understanding, the present invention is illustrated below in detail by embodiments with reference to the drawings, which are not intended to limit the scope of the present invention. It will be apparent that any modifications or alterations that can easily be accomplished by those having ordinary skill in the art fall within the scope of the disclosure of the specification.

Referring to FIG. 2, a preferred embodiment is disclosed according to the present invention, illustrating the use of a gasket made from a compressible foam to protect the glass in the metal frame from shock and stress. The gasket 21 made from a compressible foam goes in between the photovoltaic module and the perimeter frame to support the photovoltaic module. Butyl sealant 24 is optionally applied between the photovoltaic module and the gasket. Obviously, no features such as protrusions or ridges are necessary for the foamed gasket to perform its sealing function. The foamed gasket is much more compressible than conventional solid EPDM or TPV gasket, so its contact with the glass 23 and surfaces of the metal frame 25 would be much more intimate. For example, instead of requiring an “arrow” feature, the foam would naturally expand to create a plug 22.

FIG. 3 shows another preferred embodiment, illustrating the use of a gasket made from a rigid non-compressible foam to protect glass in the metal frame from shock and stress. The gasket 31 made from a rigid non-compressible foam goes in between the photovoltaic module 33 and the perimeter of the metal frame 35 to support the photovoltaic module. Butyl sealant 34 is optionally applied between the photovoltaic module and the gasket. Simpler part definition will suffice to block seepage of fluid. The rigid non-compressible foam can be made into the desired shape via fabrication methods familiar to persons having ordinary skill in the art. Exemplary methods include, but are not limited to, extrusion foaming and mechanical carving. Obviously, instead of an “arrow” feature, the foamed gasket would naturally create a plug 32.

Gaskets made from compressible foams are commonly employed in applications such as windows, building seals and automotive seals. In addition, rigid non-compressible foams are commonly employed to protect a variety of fragile products. However, they have not been employed as a protective buffer in photovoltaic modules in the same way as the present invention. Conventional solid gaskets made from materials such as thermosetting EPDM or TPU require more materials, and so have high material intensity. Producing gaskets with features such as protrusions or ridges requires extrusion profile equipment, thus raising capital costs. Moreover, these conventional gaskets are of fixed design, and thus lack material interchangeability. However, the foams used in the present invention have density in the range of 0.005 to 0.6 g/cm³. Preferably, the compressible foams have a density in the range of 0.05 to 0.25 g/cm³ and the rigid non-compressible foams have 0.02 to 0.2 g/cm³, which means that a much lower amount of material is required. In addition, applying force to a foam gasket against a solid surface will allow the gasket of the present invention fit to the contour of the surface, thus delivering a better seal. As stated above, features on solid gaskets such as protrusions or ridges to enhance sealing are not required.

In summary, the advantages of the present invention allow the photovoltaic module gasket to be produced at a significantly lower cost.

Although the present invention has been described with reference to the illustrative embodiment, it should be understood that any modifications or alterations that can easily be accomplished by persons having ordinary skill in the art will fall within the scope of the disclosure of the specification, drawings, and the appended claims.

What is claimed is:

1. A method of preparing a foamed gasket, comprising:
providing a foam having a density in the range of 0.005 to 0.6 g/cm³;
molding the foam into foam sheets; and
forming the gasket from the foam sheets.

2. The method of claim 1, wherein a polymer or polymers used to make the foam do not contain any functional groups which can be hydrolyzed.

3. The method of claim 1, wherein the foam is a compressible foam or a rigid non-compressible foam.

4. The method of claim 3, wherein the density of the compressible foam is between 0.05 to 0.25 g/cm³.

5. The method of claim 3, wherein the compressible foam can be compressed without inherent material failure by external applied force or mechanical load greater than or equal to 5% in the axis of applied force or mechanical load.

6. The method of claim 3, wherein the compressible foam has an open-celled structure or a close-celled structure.

7. The method of claim 6, wherein the surface of the compressible foam having an open-celled structure is covered with a skin layer which prevents fluids from entering the open-celled structure.

8. The method of claim 3, wherein the density of the rigid non-compressible foam is between 0.02 to 0.2 g/cm³.

9. The method of claim 3, wherein the rigid non-compressible foam has an open-celled structure or a close-celled structure.

10. The method of claim 9, wherein the surface of the rigid non-compressible foam having an open-celled structure is covered with a skin layer which prevents fluids from entering the open-celled structure.

11. A foamed gasket used in the photovoltaic module, comprising:
a foam having a density in the range of 0.005 to 0.6 g/cm³.

12. The gasket of claim 11, wherein a polymer or polymers used to make the foam do not contain any functional groups which can be hydrolyzed.

13. The gasket of claim 11, wherein the foam is a compressible foam or a rigid non-compressible foam.

14. The gasket of claim 13, wherein the density of the compressible foam is between 0.05 to 0.25 g/cm³.

15. The gasket of claim 13, wherein the compressible foam can be compressed without inherent material failure by external applied force or mechanical load by greater than or equal to 5% in the axis of applied force or mechanical load.

16. The gasket of claim 13, wherein the compressible foam has an open-celled structure or a close-celled structure.

17. The gasket of claim 16, wherein the surface of the compressible foam having an open-celled structure is covered with a skin layer which prevents fluids from entering the open-celled structure.

18. The gasket of claim 13, wherein the density of the rigid non-compressible foam is between 0.02 to 0.2 g/cm³.

19. The gasket of claim 13, wherein the rigid non-compressible foam has an open-celled structure or a close-celled structure.

20. The gasket of claim 19, wherein the surface of the rigid non-compressible foam having an open-celled structure is covered with a skin layer which prevents fluids from entering the open-celled structure.
